(19) United States
(12) Patent Application Publication
(10) Pub. No.: US 2009/0294579 A1
(43) Pub. Date: Dec. 3, 2009

(54) PRIMARY ENGINE STRUT STRUCTURE OF AN AIRCRAFT

(75) Inventors: Olivier Eve, Toulouse (FR); Jean-Pierre Cabanac, Tournefeuille (FR)

Correspondence Address: Perman & Green, LLP, 99 Hawley Lane, Stratford, CT, 06614, US

(73) Assignee: AIRBUS FRANCE, Toulouse (FR)

(21) Appl. No.: 11/997,834

(22) PCT Filed: Jul. 13, 2006
(86) PCT No.: PCT/EP06/64240

§ 371 Date: Jul. 21, 2008

(30) Foreign Application Priority Data
Aug. 5, 2005 (FR) 05 52439

(51) Int. Cl. B64D 27/26

(52) U.S. Cl. 244/54

(57) ABSTRACT

The disclosed embodiments relate to a primary engine strut structure of an aircraft characterized in that it includes single-piece composite panels while replacing the metallic spars and metal panels, the composite panels having a lay-up of fibers oriented along crosswise directions whereby integrating, in the width of the skin of the panles, a lattice structure that replaces longitudinal and transversal stiffeners of the spars and metal panels.

### CROSS-REFERENCE TO RELATED APPLICATIONS

This application is the National Stage of International Application No. PCT/EP2006/064240, International Filing Date, Jul. 13, 2006, which designated the United States of America, and which international application was published under PCT Article 21(2) as WO Publication No. WO 2007/017339 and which claims priority from French Application No. 0552439, filed Aug. 5, 2005.

### BACKGROUND

1. Field

The disclosed embodiments relate to the production of aircraft engine strut primary structures that are improved insofar as the number of parts of which they are made is lower and insofar as the mass of said parts is itself lower through the use of composite materials.

2. Brief Description

Aircraft engine struts make the connection between the engines and the wing structure of the aircraft.

They comprise a primary structure which transfers load between the engine and the wing structure. This structure has to be engineered both statically and for fatigue, is subject to significant thermal stresses because it is in contact with the hot regions of the engine, and is subject to high risks of corrosion.

Furthermore, the width and depth of this structure have a direct impact on the aerodynamics of the airplane.

Struts also comprise a secondary structure that complements the primary structure but does not react load. This secondary structure acts as aerodynamic streamlining between the leading edges of the engine and the wing structure, protects and segregates systems such as hydraulic systems, electrical systems, fuel systems, air-conditioning systems or other systems that run through the strut and supports the engine cowls and nacelles.

The primary structure generally consists of a box section made up of a front upper spar, a rear upper spar, a lower spar, ribs and two lateral panels.

The structural connections are generally made, on the one hand, to the wing structure by three fixings, a front fixing, a rear fixing and a top fixing known as the spigot and, on the other hand, to the engine by two fixings, a front fixing positioned at the tip of an engine mount, and a rear fixing.

The engine mount allows the engine to be set forward relative to the wing.

According to the prior art, the fixings consist of fittings which are parts separate from the spars and from the panels.

These panels are also provided with stiffeners in the longitudinal and transverse directions.

### SUMMARY

It is an aim of the disclosed embodiments to make this construction less complicated and less heavy and in order to do that, the disclosed embodiments relate chiefly to an aircraft engine strut primary structure characterized in that it comprises composite one-piece panels to replace metal spars and metal panels, said composite panels comprising a layup of the fibers orienting these fibers in crossing directions so as to incorporate into the thickness of the skin of the composite panels a mesh structure that replaces the longitudinal and transverse stiffeners of the metal spars and panels.

The disclosed embodiments make it possible to omit the stiffeners and offers greater flexibility in the production of the strut by adapting the layup in the regions where load is introduced into the structural parts of the strut.

### BRIEF DESCRIPTION OF THE DRAWINGS

Other features and advantages of the disclosed embodiments will be better understood from reading the description which will follow of one exemplary embodiment of the disclosed embodiments with reference to the drawings which depict:

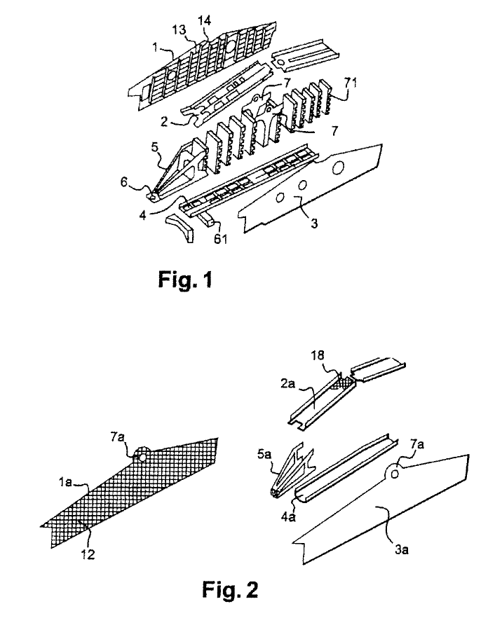

in FIG. 1: an exploded view of a primary structure of a strut of the prior art;

in FIG. 2: an exploded view of a structure according to the disclosed embodiments;

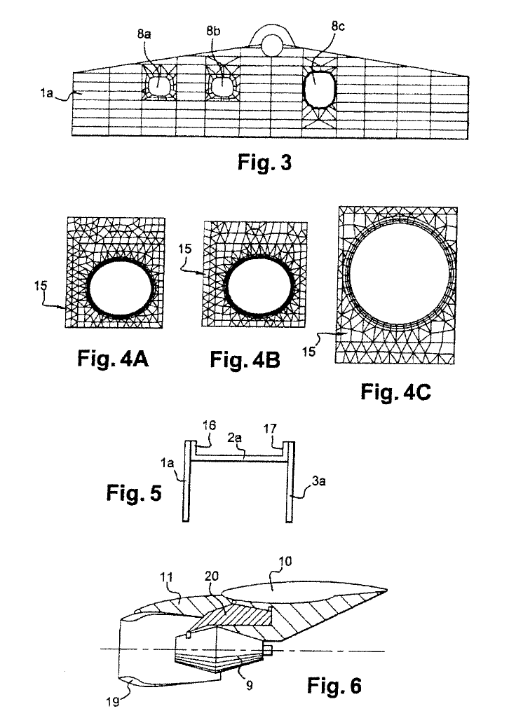

in FIG. 3: a side view of a lateral panel of the structure of FIG. 2;

in FIGS. 4A, 4B, 4C: details of FIG. 3;

in FIG. 5: a schematic view of an assembly of panels according to the disclosed embodiments;

in FIG. 6: an overall view of an engine fixed to a wing structure of an aircraft.

### DETAILED DESCRIPTION

The fixing of engines under the wing structures of aircraft call for a load-bearing strut. A fixing such as this is depicted schematically in FIG. 6 which depicts the engine 9, the engine fan cowling 19, the wing structure 10, the cowling 11 of the engine-bearing strut and the primary structure 20 of this strut.

The primary structure 20, darkened in the figure, comprises the fixings for attaching the engine to the wing structure and has the purpose of supporting the engine, of transmitting the tensile loads from the engine and preventing vibrations from being transmitted.

This structure comprises points for attaching the engine and points for attachment to the wing structure.

A primary structure of the prior art is depicted in FIG. 1.

The primary structure of FIG. 1 consists of metal upper 2 and lower 4 spars and of metal lateral panels 1, 3. Inside the box section reinforcing ribs give the structure rigidity.

Still according to the prior art, the metal spars are provided with longitudinal 13 and transverse 14 stiffeners. The parts produced are complex machined metal parts and the mass of the whole remains great.

According to the disclosed embodiments, the aircraft engine 9 strut 11 primary structure comprises composite one-piece panels 1a, 2a, 3a, 4a to replace metal spars 1, 2 and metal panels 3, 4 of the primary structure of the prior art.

The composite panels according to the disclosed embodiments are produced using a layup 12 of the fibers orienting these fibers in crossing directions so as to incorporate into the thickness of the skin of the panels a mesh structure that replaces the longitudinal 13 and transverse 14 stiffeners of the metal spars.

FIG. 3 more specifically depicts the composite lateral panels 1a, 3a of the structure in relation to the loads applied particularly in the region of the inspection holes 8a, 8b, 8c, the layup of the composite lateral panels including reinforcing regions 15 around the inspection holes.

The layup of these composite panels is a layup of the quasi-isotropic (25/25/25/25) type in order to ensure that load is reacted uniformly within the material of the panels.

With reference to FIG. 1, the aircraft engine strut primary structure comprises fittings for attaching the engine to the strut and for attaching the strut to the wing structure 10 of the aircraft.

In the prior art, these fittings 6, 7, 71, 61 consist of parts attached to the primary structure.

According to FIG. 2, which depicts one particular embodiment of the disclosed embodiments, at least some of the fittings, particularly the fittings 7a which are fittings for attaching the strut to the wing structure 10, are incorporated into the composite lateral panels 1a, 3a.

This embodiment offers the box section that makes up the primary structure greater cohesion because the loads in the fixings are applied directly to the panels.

To produce the box section that constitutes the primary structure, at least one upper spar 2a is provided with rims 16, 17 for connection to the lateral panels 1a, 3a.

These rims 16, 17 are directed out towards the outside of the structure so that the upper and lateral panels can easily be attached from outside the box section. Furthermore, this method of attachment increases the rigidity of the whole.

The upper spar 2a is a composite spar produced using a layup of the highly oriented (50/20/20/10) type offering a great longitudinal rigidity.

According to one advantageous embodiment of the disclosed embodiments, the layup of said upper spar 2a is reinforced in the regions 18 where load will be introduced, particularly in the regions contiguous with the fittings produced in the lateral panels. The engine front fixing is performed using a fitting situated at the end of an engine mount 5a, supporting the front fixing 6 for attaching the strut to the engine 9.

According to one advantageous embodiment of the disclosed embodiments, at least the beams of the engine mount are made of composite materials.

The disclosed embodiments are not restricted to the exemplary embodiments depicted and in particular the rear fitting 71 for fixing the strut primary structure to the wing structure can also be incorporated into the lateral panels.

1. An aircraft engine (9) strut (11) primary structure characterized in that it comprises composite one-piece panels (1a, 2a, 3a, 4a) to replace metal spars (1, 2) and metal panels 3, 4, said composite panels comprising a layup (12) of the fibers orienting these fibers in crossing directions so as to incorporate into the thickness of the skin of the panels a mesh structure that replaces the longitudinal (13) and transverse (14) stiffeners of the metal spars and panels.

2. The aircraft engine strut primary structure as claimed in claim 1, characterized in that the lateral panels (1a, 3a) of the structure are composite panels.

3. The aircraft engine strut primary structure as claimed in claim 2, comprising fittings for attaching the engine to the strut and for attaching the strut to the wing structure (10) of the aircraft, characterized in that at least some of the fittings (7a) are incorporated into the composite lateral panels (1a, 3a).

4. The aircraft engine strut primary structure as claimed in claim 3, characterized in that the fittings (7a) incorporated into the composite lateral panels are fittings for attaching the strut to the wing structure (10).

5. The aircraft engine strut primary structure as claimed in claim 2, characterized in that with the composite lateral panels comprising inspection holes (8a, 8b, 8c) the layup of the composite lateral panels includes reinforcing regions (15) around the inspection holes.

6. The aircraft engine strut primary structure as claimed in claim 1, characterized in that it comprises at least one composite upper spar (2a) provided with rims (16, 17) for connection to the composite lateral panels (1a, 3a).

7. The aircraft engine strut primary structure as claimed in claim 4, characterized in that the composite upper spar 2a is produced using a layup of the highly oriented (50/20/20/10) type.

8. The aircraft engine strut primary structure as claimed in claim 6, characterized in that the layup of said composite upper spar (2a) is reinforced in the regions (18) where load will be introduced.

9. The aircraft engine strut primary structure as claimed in claim 1, comprising an engine mount (5a) supporting a front fixing (6) for attaching the strut to the engine (9), characterized in that at least the beams of the engine mount are made of composite materials.

10. The aircraft engine strut primary structure as claimed in claim 1, characterized in that the layup of the composite panels is a layup of the quasi-isotropic type.
